(19) United States
(12) Patent Application Publication
(10) Pub. No.: US 2026/0072766 A1
(43) Pub. Date: Mar. 12, 2026

(54) Electronic Game Operating System Based On Linux

(71) Applicant: Ao Zhang, Shenzhen City (CN)

(72) Inventor: Ao Zhang, Shenzhen City (CN)

(21) Appl. No.: 18/826,867

(22) Filed: Sep. 6, 2024

(51) Int. Cl. G06F 9/54; A63F 13/45; G06F 9/48

(52) U.S. Cl. CPC G06F 9/542; A63F 13/45; G06F 9/4881

(57) ABSTRACT

An operating system based on Linux includes a presentation layer, a business logic layer, a data interface layer and a database. The presentation layer displays the data and receives the data input from the users. The business logic layer is used for business logic processing of the data provided by the data interface layer and provides the electronic game service to the presentation layer through the API interface. The business logic layer also sets the multi-task scheduling module, the driver and update module of hardware and the combination of software and hardware application module. The data interface layer is used for the access of the database and provides the data service for the business logic layer and the presentation layer. The database is used to cache the data provided by the data interface layer and persistently store the data in the cache.

### FIELD OF THE INVENTION

The invention relates to the field of Internet technology, in particular to an electronic game operating system based on Linux.

### BACKGROUND OF THE INVENTION

With the continuous improvement of people's living standards, people's entertainment demand is getting higher and higher. More and more people like to play electronic games in spare time, so electronic games are a popular way of entertainment for people to relax in leisure time. With the rapid development of Internet technology, various kinds of electronic games spread throughout the Internet. In the personal computer platform with X86 architecture, electronic games run OS based on Windows, but as a comprehensive system for a long time, the iteration of Windows brings excessive pressure on the operation of computer hardware and software. In the field of electronic games, the resource occupation services and tasks such as system processes and services that need to be called when running games are actually much lower than the resource occupation of Windows system, and as much as 30% of computing power is wasted due to the resource occupation of Windows system.

It should be noted that the introduction of the technical background is only to facilitate a clear and complete description of the technical solution of this invention and to facilitate the understanding of the technicians in this field. It shouldn't be considered that the above technical solutions are known to those skilled in this field only because these technical solutions are described in the background of this invention.

### SUMMARY OF THE DISCLOSURE

In view of this, it is necessary to provide an electronic game operating system based on Linux for the problem of excessive operating pressure of software.

The invention provides an electronic game operating system based on Linux, which is set from top to bottom: presentation layer, business logic layer, data interface layer and database.

The presentation layer displays the data and receives the data input from the users, and the interactive operating interface of the presentation layer is created based on the desktop system of Linux.

The business logic layer is used for business logic processing of the data provided by the data interface layer and provides the electronic game service to the presentation layer through the API interface. In which, the electronic game service at least includes the game management service, the device management service, the user management service and the application management service. The business logic layer also sets the multi-task scheduling module, the driver and update module of hardware and the combination of software and hardware application module.

The data interface layer is used for the access of the database and provides the data service for the business logic layer and the presentation layer.

The database is used to cache the data provided by the data interface layer and persistently store the data in the cache.

In an embodiment, the aforementioned multi-task scheduling module could be used to temporarily save the current game process according to the historical game data of users so that the users can switch different games; the aforementioned driver and update module of hardware could be used to manage and update the firmware and driver of the hardware, and the cloud server is tracked in real-time state in combination with the terminal device of the electronic game to ensure that the terminal device uses the verified latest version of firmware and driver; the aforementioned combination of software and hardware application module could achieve the function of opening a multifunctional menu in the electronic game interface through the combination of the aforementioned API interface and the physical function key, in which the aforementioned function key could be preset single key or combined key.

In an embodiment, the interactive operating interface of the aforementioned presentation layer provides the users with controller operation and touch operation and adapts to the size of the terminal equipment of electronic game. The presentation layer is developed based on the Electron framework and completes the interaction between users and data by means of WEB.

In an embodiment, the aforementioned game management service is configured with PC game management, PC game metadata management, retro game management, retro game metadata management, controller settings and simulator settings; the aforementioned device management service is configured with WiFi management, bluetooth management, file management, time zone and time settings, device information view and device power consumption adjustment; the aforementioned user management service is configured with function of screenshots, sharing of screenshots and synchronization of game data; the aforementioned application management service is configured with application installation, application upgradation and application deletion.

In an embodiment, the aforementioned data interface layer includes data cache, custom functions, transactions, database reading/writing, and files reading/writing; the database includes MySQL, Json, MongoDB, CDN.

In an embodiment, the aforementioned database uses Redis cache to save the data provided by data interface layer, and realizes the concurrent preemption and processing of the data in cache of Redis, and the processed data could be persistently stored in the database through the message queue.

In an embodiment, the interactive operating interface of the aforementioned presentation layer is created based on the Linux desktop system, which includes:

Obtain screen information of terminal devices of electronic game, which includes at least screen size and/or screen resolution.

Based on the aforementioned screen information, the data provided by the business logic layer is configured to display the game list of the electronic game.

Receive the operation request information of the quick functional area, and display the preset adjusting module of the quick functional area, which is used to adjust the power consumption state of the terminal devices, limit the temperature of the terminal devices, and adjust the screen brightness and volume of the terminal devices.

In an embodiment, the aforementioned list of games contains at least the name and cover of the electronic game, and the quick functional area.

In an embodiment, the aforementioned multi-task scheduling module comprising:

Unit of creating process, used for creating data process of users that includes multiple task state queues, which includes at least ready queue, wait queue, mutually exclusive queue, and end queue.

Unit of finding task, is used to determine the priority of the running tasks according to the data process provided by the unit of creating process, and preemptively run according to the priority of tasks.

Unit of timing, is used to set the time for unit of finding task.

Unit of interrupting process, is used to call the preset entry function of interrupting process of Linux when the users interrupt the game process.

Unit of saving data, is used for saving game data processed by the unit of interrupting process.

In an embodiment, it further comprises the WiFi network module used for automatically scanning the available networks. The game content management module used to automatically import, identify, and optimize the local game content of users to ensure the comprehensive game experience.

The technical solutions provided by this invention has at least the following beneficial effects:
1. The interactive operation interface of the presentation layer provides controller operation and touch operation for users, and completely conforms to the long-term usage habits of current users, which could helps gamers to set and adjust games, systems and hardware more quickly and conveniently, and could also performs conveniently management of game contents, rapidly operation of devices, and seamless call of game;
2. The multi-task scheduling module temporarily saves the current game process according to the users'historical game data, so that the users can switch different games and improve the use experience of the devices and the systems;
3. The technical solutions could improve the performance and efficiency of operation, optimize the priority of game process, so as to ensure the fully performance of hardware and better game experience;
4. With the cooperation of multiple modules, the business logic layer is more energy-saving and provides a longer battery life.
5. The technical solutions can optimize the game experience, and provide more efficient and immersive services for users.

### BRIEF DESCRIPTION OF THE DRAWINGS

Other features, objects and advantages of the present invention could be more apparent through detailed description of non-limiting embodiments with reference to the following drawings:

FIG. 1 is a structural diagram of an electronic game operating system based on Linux in the embodiment of the present invention.

FIG. 2 is a structural diagram of the multi-task scheduling module of an electronic game operating system based on Linux in the embodiment of the invention.

### DETAILED DESCRIPTION OF THE PREFERRED EMBODIMENTS

Hereinafter, embodiments of the present invention will be described in detail with reference to the accompanying drawings. Therefore, the present invention should not be construed as being limited to the description of the following embodiments.

It should be noted that the terms “a”, “an”, “aforementioned” and “the” used here can also include plural forms unless specifically stated. Furthermore, the terms “including”, “comprising” [symbol] “having” and any variations thereof, are intended to cover non-exclusive inclusion, for example, features, integers, steps, operations, elements and/or components, not necessarily limited to those listed, but may include other features, integers, steps, operations, elements and/or components and/or groups thereof.

In addition, the terms “In an embodiment”, “first embodiment”, etc. means that particular features, integers, steps, operations, elements and/or components described in connection with the embodiment or example is included in at least one embodiment of the present invention. Thus, appearances of the these phrases in various places throughout this invention are not necessarily all referring to the same embodiment or example.

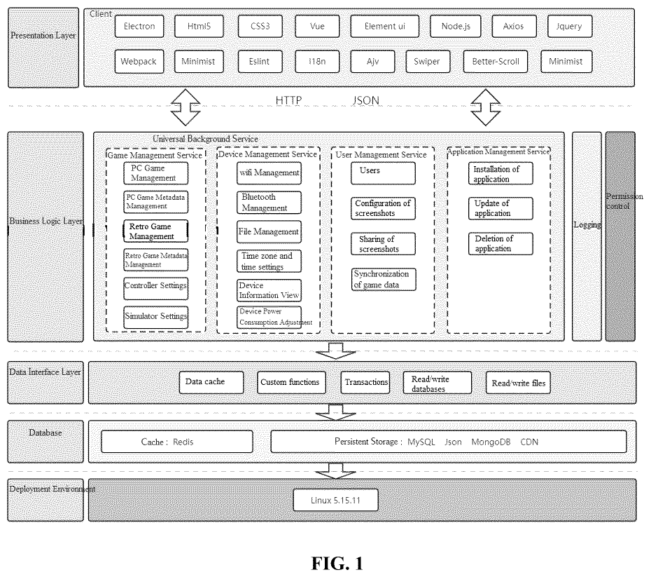

Referring to FIG. 1, the specific contents of the embodiments in this invention are described below. The first embodiment of an electronic game operating system based on Linux of this invention includes:

This electronic game operating system is one kind of operating system based on the secondary development of Linux and oriented to electronic game users. The system has the advantages of stable performance, energy saving, power saving, and convenient to use. Firstly, it could provide more excellent performance on the low-power computing platform, meets the users'demand of playing games more smoothly; It could improve the performance and efficiency of operation, optimize the priority of game process, so as to ensure that the fully performance of hardware and better game experience; It could also optimize the game experience, and provide more efficient and immersive services for users. Linux is a fully open source operating system with better stability, better reliability and lower development and use cost. In addition, Linux supports processors with a variety of architectural, making the software has strong portability; Linux has the perfect module mechanism, compilation and configuration mechanism, which is highly customizable.

This electronic game operating system based on Linux is set from top to bottom: presentation layer, business logic layer, data interface layer and database , The electronic game operating system further includes WiFi network module used for automatically scanning the available networks and game content management module used to automatically import, identify, and optimize the local game content of users to ensure the comprehensive game experience. In which, the deployment environment of this operating system could be Linux 5.15.11, but not specific limited in this invention.

The presentation layer displays the data and receives the data input from the users, and the interactive operating interface of the presentation layer is created based on the desktop system of Linux.

In this embodiment, the interactive operating interface of the presentation layer provides the users with controller operation and touch operation and adapts to the size of the terminal equipment of electronic game. The presentation layer is developed based on the Electron framework and completes the interaction between users and data by means of WEB. The interactive operation interface of the presentation layer provides controller operation and touch operation for users, and completely conforms to the long-term usage habits of current users, which could helps gamers to set and adjust games, systems and hardware more quickly and conveniently, and could also performs conveniently management of game contents, rapidly operation of devices, and seamless call of game. The presentation layer is located in the outermost layer (uppermost layer) closest to the users and is used to display data and receive data entered by the users, providing an interactive operation interface for the users. Electron framework is used for development, and Electron provides rich local (operating system) APIs, which are convenient to deploy and upgrade, and HTML/JS/CSS writing is convenient and efficient.

The presentation layer includes: Electron, Html 5, CSS3, Vue, Element Li, Node.js, Axios, Jquery, Webpack, Minimist, Eslint, 118n, Ajv, Swiper, Better-Scroll, Minimist.

The graphical interface of Linux desktop system brings a lot of convenience in terms of use and computer management. Firstly, Linux is usually relatively stable, with very low failure rate and system maintenance time, which could avoid the interference of viruses, spyware software, advertising software and some Trojan programs to a certain extent. Secondly, Linux fully supports the file format of dos, the files and everything below Microsoft can be copied to Linux system, Linux could support nearly 20 kinds of file systems, files from different machines can be used as if they were on one machine with NFS file system. Lastly, the pure Linux desktop system lacks friendly user interface, the operating program for small-size (less than 10 inches) display devices is still immature and not easy for the controller to operate, while this operating system is developed for low-resolution and small-size display devices combined with the data of electronic game players. This operating system provides controller operation and touch operation for users, which is completely conforms to the long-term accumulated habits of current users, and performs conveniently management of game contents, rapidly operation of devices, and seamless call of game, which could provide better operation experience that Linux desktop system has not previously had.

The interactive operating interface of the presentation layer is created based on the Linux desktop system, which includes:

Obtain screen information of terminal devices of electronic game, which includes at least screen size and/or screen resolution.

Based on the aforementioned screen information, the data provided by the business logic layer is configured to display the game list of the electronic game, the game list contains at least the name and cover of the electronic game, and the quick functional area.

Receive the operation request information of the quick functional area, and display the preset adjusting module of the quick functional area, which is used to adjust the power consumption state of the terminal devices, limit the temperature of the terminal devices, and adjust the screen brightness and volume of the terminal devices.

Receive the operation request information of the quick functional area, and display the preset adjusting module of the quick functional area, which is used to adjust the power consumption state of the terminal devices, limit the temperature of the terminal devices, and adjust the screen brightness and volume of the terminal devices.

During the specific operation process: the home pages of terminal devices display the list of games finally started by the device, including name and cover of the electronic game, quick functional area and other information. There is quick functional area on the right side, which can be clicked to carry out further interaction. After the quick functional area is expanded, it can quickly adjust the power consumption state of terminal devices, limit the temperature of terminal devices, and adjust the screen brightness and volume of terminal devices. At the same time, the quick button could be set at the bottom of the terminal devices, and some functions of the terminal devices can be quickly controlled by clicking it, but the specific mode is not limited in the present invention.

The business logic layer is used for business logic processing of the data provided by the data interface layer and provides the electronic game service to the presentation layer through the API interface. In which, the electronic game service at least includes the game management service, the device management service, the user management service and the application management service. The business logic layer also sets the multi-task scheduling module, the driver and update module of hardware and the combination of software and hardware application module;

In this embodiment, the game management service is configured with PC game management, PC game metadata management, retro game management, retro game metadata management, controller settings and simulator settings. The device management service is configured with WiFi management, bluetooth management, file management, time zone and time settings, device information view and device power consumption adjustment. The user management service is configured with function of screenshots, sharing of screenshots and synchronization of game data; the aforementioned application management service is configured with application installation, application upgradation and application deletion. With the cooperation of multiple modules, the business logic layer is more energy-saving and provides a longer battery life.

The business logic layer is mainly aimed at the operation of specific problems, and it could also be understood as the operation of the data interface layer to perform business logic processing on data. The business logic layer provides various services to the front-end through API interface, including the game management service, the device management service, the user management service and the application management service, etc., which enables the front-end having better page performance, faster speed, better compatibility and user experience, etc. If compare the data interface layer to building block, the business logic layer is to build these building blocks, which is undoubtedly part of the system architecture with core values. Its focus is mainly on the development of business rules, implementation of business process and other system design related to business needs, that is, it is related to the domain logic that the system responds to, so in many times, the business logic layer is also called the domain layer. The location of business logic layer in architecture is critical, it is between the data access layer and presentation layer, which plays the connecting role of data exchange. Changing the design of the upper layer has no effect on the bottom layer because the layer is a weak coupling structure, the dependence between layer and layer is downward and the bottom layer is “ignorant” for the upper layer. If the idea of interface oriented design is followed in layered design, this downward dependency should also be a weak dependency. Therefore, without changing the interface definition, the ideal layered architecture should be a “drawer” architecture that supports extractable and replaceable. Because of this, the design of the business logic layer is particularly critical for the framework supporting scalability because it plays two different roles, caller for the data interface layer and callee for the presentation layer.

Business logic layer also includes logging, authority control, etc. Linux system has strict control over the authority of files, which means that if an operation is performed on a file, it must have the corresponding permissions before it can be successfully executed. The types of permissions for files under Linux generally include reading, writing, and execution, and the corresponding letters are r, w, x. There are three kinds of granularity of authority under Linux: owner, group and other groups, each file could have different rwx (read, write and execution) permissions for three granularities. In general, a file can only belong to one user and group. If other users want to have permission for this file, they can join the group with permission, and a user can belong to multiple groups at the same time. Permissions to files on Linux are typically set and changed by the “chmod” command. In Linux system, the attribute of file is represented by 10 characters, the first character indicates the type of the file, and the remaining nine characters are divided into three groups, each with three characters, which respectively indicate the owner, group and other people's access rights to the file. Each group represents the permission to read, write, and execute in turn. If there is no permission, it will be displayed as **-**.

The data interface layer is used for the access of the database and provides the data service for the business logic layer and the presentation layer. The database is used to cache the data provided by the data interface layer and persistently store the data in the cache.

In this embodiment, the data interface layer includes data cache, custom functions, transactions, database reading/writing, and files reading/writing. The database includes MySQL, Json, MongoDB, CDN. The database uses Redis cache to save the data provided by data interface layer, and realizes the concurrent preemption and processing of the data in cache of Redis, and the processed data could be persistently stored in the database through the message queue.

The function of data interface layer is mainly responsible for database access, which can access database system, binary files, text documents or XML documents. To put it simply, it is to implement the operations of Select, Insert, Update and Delete on the data table. If adding ORM elements, it will include the mapping between objects and data tables, and the persistence of object entities. It is mainly the operation layer of raw data (database or text file, etc.), rather than raw data, that is to say, it is the operation of data, rather than database, and provides data services for business logic layer or presentation layer.

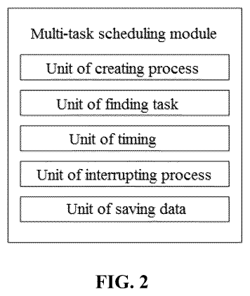

Referring to FIG. 2, the second embodiment of the electronic game operating system based on Linux in the embodiment of the present invention includes:

The multi-task scheduling module could be used to temporarily save the current game process according to the historical game data of users so that the users can switch different games. The driver and update module of hardware could be used to manage and update the firmware and driver of the hardware, and the cloud server is tracked in real-time state in combination with the terminal device of the electronic game to ensure that the terminal device uses the verified latest version of firmware and driver. The combination of software and hardware application module could achieve the function of opening multifunctional menu in the electronic game interface through the combination of the aforementioned API interface and the physical function key, in which the aforementioned function key could be preset single key or combined key.

Aiming at the conflict between the native single-thread characteristic of Linux and the multi-thread processing of game device, the invention develops a unique intelligent game multi-task scheduling module based on Linux system. The multi-task scheduling module will temporarily save the game process in the memory according to the users'historical game data, so that the users can quickly switch 1-3 different games to improve the use experience of the devices and systems. Therefore, the operating system of this embodiment has the performance advantage of multi-tasking, which could execute several tasks at the same time when the program is running, and each task is independent of each other and does not interfere or affect each other during the execution process.

In this embodiment, the multi-task scheduling module could be used to temporarily save the current game process according to the historical game data of users so that the users can switch different games to improve the use experience of the devices and systems. The multi-task scheduling module includes:

Unit of creating process, used for creating data process of users that includes multiple task state queues, which includes at least ready queue, wait queue, mutually exclusive queue, and end queue.

In this embodiment, when the multi-task scheduling module is started, the unit of creating process will create a user-state process as the basic user data process, and then create (N−1) threads in the process according to the number of cores N of the processor. Wait queue is waiting for the occurrence of an event or the change of state, and some tasks will actively wait. Mutually exclusive queue means that when a task is blocked by the mutually exclusive operation, it will take the task out of the blocked queue and put it in the ready queue when the mutex is released. End queue means that when a task finishes running, it will be put into the end queue and triggers multi-task scheduling. When multi-tasking is running, it will check whether the resources occupied by the tasks in the end queue are used by other running tasks, so as to clean up the space occupied by the tasks in time.

Unit of finding task, is used to determine the priority of the running tasks according to the data process provided by the unit of creating process, and preemptively run according to the priority of tasks.

In this embodiment, in combination with the ready queue in the unit of creating process, each priority has a corresponding ready queue. The ready queue organizes the task descriptor in the form of bidirectional circular linked list, and uses an array with a length of 64 to store the queue information of the ready queue. The lower the priority value is, the higher the task priority is. Whenever scheduling is needed, the ready queue with the highest priority and tasks will be found according to the optimal scheduling algorithm.

Unit of timing, is used to set the time for unit of finding task. In this embodiment, the timing task is the task that needs to be executed at a specified time or is periodically executed, and the Linux system will have built-in “at” and “cron” services, with “at” service being used to execute the task at a specified time and “cron” being used to execute the task periodically. Linux crontab is used for “crontab” commands, which are common in Unix and Unix-like operating systems, and are used to set instructions to be executed periodically. This command reads the instruction from the standard input device and stores it in the “crontab” file for later reading and execution. Usually, the instructions stored by “crontab” are activated by a daemon, and “crond” often runs in the background, checking whether there are scheduled jobs to be executed every minute. This kind of job is generally called “cron jobs”. When the operating system is installed, this task scheduling command is started by default. The “crond” command periodically checks whether there is any work to be executed every minute, and if there is any work to be executed, it will automatically execute it.

Unit of interrupting process, is used to call the preset entry function of interrupting process of Linux when the users interrupt the game process.

In this embodiment, when an interrupt occurs, the Linux system will jump to asm_do_IRQ( ) function (the total entry function of all interrupt programs), and interrupt the irq_desc structure corresponding to the interrupt number “irq” (irq_desc structure is the description structure of interrupts in the kernel, and there is an array irq_desc_ptrs [NR_IRQS] of irq_desc structure in the kernel), and then call the handle_irq function in irq_desc, that is, the interrupt entry function. We write the driver of interrupt, that is, fill and register irq_desc structure.

Unit of saving data, is used for saving game data processed by the unit of interrupting process.

In this embodiment, the built-in WiFi network module can automatically scan available networks, and can be connected after inputting a password, this link could also be skipped by pressing the “Y” key on the controller. After completing the configuration protocol, the operating system will enter the final release, and the operating system will also be optimized for the first loading. When the mobile terminal is operated, the front page could be moved down to enter the two-screen mode. Through the cloud server, the game libraries or high-scoring games that may be of interest to users could be commended, or help players to find games that have not yet been played. At the top right corner of the homepage, the floating window could be expanded from the status bar avatar, including data synchronization, function introduction, and account registration and login. When switching to the PC library, all PC game contents installed in this device can be viewed, and the automatically matched covers and names will be displayed, which will be arranged in the order of design or user selection. Different game contents could be selected by using the controller or touch control, when entering the details page of the game content, more game introductions and art materials can be seen and click “Start Play” to automatically run the game. Users could enter into the search function when pressing the window key in the game list and according to the locally installed game content, users could quickly sort and process all the game contents by initials, types and publishers. With up to three games, players can quickly find the game they want to play from tens of thousands of games, which greatly improves the efficiency. During the search and fold state, the design of quickly moving out options is also designed, the operation is simple, and the current list can be refreshed after clicking. Press RS (right joystick of controller) in the game library list to expand the arrangement function, after selecting the arrangement options, users could refresh the game list. Retro library is uniquely designed for older game content based on the functional logic of PC library, games on non-PC platforms will be displayed here, retro library could identify the running platform of games through independent label design, in order to improve the users'experience. As long as the cursor stays on the cover of the game, users could enter the preview mode when there are historical images and videos in the matched data. Press “Y” to directly run the game, press “A” or touch to enter into the details page. In the search function, an additional filtering navigation logic is designed aiming at the complexity of the retro game content, filtering items could be added from the game system just by clicking “switch”, and the user experience is more friendly by combining the name and graphic type. In order to simplify the acquisition of common Linux software and manage local software more conveniently, an independent application center is designed, through the portal and list, my applications, recommended applications and all application lists can be accessed. For the selected application, press “Y” to run directly, or press “Y” to install or update if the game is not installed, press “A” or touch click to enter the software introduction page. In the introduction page of the software, you can download, update and run applications, and you can also uninstall the installed applications. When entering “My Application”, users could see the locally installed applications, quickly switch the classification to get the update status and basic information of the application, and also run and view them. The user-friendly operation interface and basic tools provided by the game assistant, which could quickly check all common problems by clicking or controller in the shortcut, and manage local files or access online communities to get information and help. Through deep system integration, the functional options of different controllers can be quickly selected in this functional area, and then further fine-tuning can be used to make the equipment more in line with the usage habits. the simulator configuration provides a convenient operation experience for retro gamers, which can perform menu-based visual operations, quickly complete their own private game startup configuration and set up whole or independent game system. Users could hide the menu UI through the button to get a more immersive preview effect. Game gallery provides users with a cross-end experience of game screenshot transfer and sharing, one-click screenshot on the device side, automatically upload it to the cloud, scan the code or open the web manager to see the picture. Click to enter into the handheld update, users will automatically get the update information online when start, or could click to detect the update. Click or select the corresponding drive and firmware through the controller, which will help the player to install with one click. During the game, press the preset shortcut key to open the multitasking quick setting window, and users could quickly adjust the hardware and performance of the equipment in the quick setting on the right. When running the retro game, the system will intelligently call up the quick setting menu of the corresponding software, and click it to realize the corresponding function operation. After clicking add widget, users could select from the preset widget in the system and add it to this page, which is convenient for further function expansion.

In this embodiment, the performance and efficiency of the same game under the same TDP are improved by 30% compared with the Windows 64-bit system. In addition to relying on the efficient and concise bottom layer of Linux, the operating system also optimizes the priority of applications and game processes to ensure that the performance of hardware could be fully utilize and better game experience can be brought about. The operating interface of the operating system is designed for small-sized devices, and conforms to the usage habits of players of electronic games. At the same time, through modern and friendly interactive logic, it helps gamers to set and adjust games, systems and hardware more quickly and conveniently. Compared with the previous Linux operating system, the operability has been greatly improved. Compared with Windows 64-bit system, the business logic layer of Linux, with simple underlying system and the cooperation of multiple modules, is more energy-saving and provides longer battery life.

The electronic game operating system based on Linux is described above, and the electronic game operating method based on Linux in the embodiment of the present invention is described in the following, which includes:

Users can operate electronic games through terminal equipment, displays the data and receives the data input from the users through interactive operation interface.

Business logic processing is performed on the data input by the interface, and electronic game service is provided through API interface.

Then access the database, save the data by Redis cache, realizes the concurrent preemption and processing of the data in cache Redis, and the processed data could be persistently stored in the database through the message queue.

In this embodiment, users play electronic games through terminal equipment. Then the process is, display data and receive data input by users through an interactive operation interface, perform business logic processing on the data input by the interface, provide electronic game services through an API interface, access the database, adopt Redis cache data to realize concurrent preemption and processing of data in Redis cache, and the persistently store the processed data is in the database through a message queue. This improves the performance and efficiency of operation, optimizes the priority of the game process, so as to ensure that the fully performance of the hardware, bring better game experience, and provide more efficient and immersive services for users.

The hardware processing of the electronic game operating device based on Linux is described in details in the following:

The electronic game operating device based on Linux may vary greatly due to different configurations or performances, and may include one or more central processing units (CPU) and memory, and one or more storage media (such as one or more mass storage devices) for storing application programs or data. Among them, the memory and storage medium can be transient storage or persistent storage. The program stored in the storage medium may include one or more modules (not shown in the figure), and each module may include a series of instruction operations on the electronic game operating device based on Linux. Furthermore, the processor can be configured to communicate with the storage medium and execute a series of instruction operations in the storage medium on the electronic game operating device based on Linux.

The electronic game operating device based on Linux may also include one or more power supplies, one or more wired or wireless network interfaces, one or more input and output interfaces, and/or one or more operating systems, such as Windows Serve, Mac OS X, Unix, Linux, FreeBSD, etc. The technicians skilled in this field could understand that the structure shown in the figure does not constitute the limitation on the electronic game operating device based on Linux, and may include more or fewer components than those shown in the figure, or a combination of certain components, or a different arrangement of components.

The invention also provides the electronic game operation device based on Linux, which comprises the memory and processor, wherein the memory stores computer-readable instructions, and when the computer-readable instructions are executed by the processor, the processor executes the steps of the aforementioned electronic game operation method based on Linux in the above embodiments.

The present invention also provides a computer-readable storage medium, which may be a nonvolatile computer-readable storage medium or a volatile computer-readable storage medium. The computer-readable storage medium stores corresponding instructions, which will bring the computer to execute each step of the electronic game operation method based on Linux when running on the computer,.

It can be clearly understood by the technicians in this filed that for the convenience and conciseness of description, the specific working processes of the above-described systems, devices and units can refer to the corresponding processes in the aforementioned method embodiments, and will not be repeated here.

If the aforementioned integrated unit is implemented in the form of a software functional unit and sold or used as an independent product, it can be stored in a computer-readable storage medium. Based on this understanding, the technical solutions of the present invention can essentially or the part that contributes to the existing technology, all or part of the technical solutions can be embodied in the form of software products, which are stored in a storage medium and includes a number of instructions to make a computer device (which could be a personal computer, a server, or a network device, etc.) perform all or part of the steps of the aforementioned methods described in various embodiments of the present invention. The aforementioned storage media include: U disk, mobile hard disk, read-only memory (ROM), random access memory (RAM), magnetic disk or optical disk and other media that can store program codes.

The above embodiments of the present invention disclosed above are provided only to help illustrate the present invention. The embodiments do not exhaust all the details, nor do they limit the invention to the specific embodiments described. Obviously, many modifications and variations are possible in light of the contents of this specification. The present specification selects and specifically describes these embodiments in order to better explain the principles and practical applications of the present invention, so that those skilled in this field can well understand and utilize the present invention. The present invention is to be limited only by the claims and their full scope and equivalents.

What is claimed is:

1. An electronic game operating system based on Linux, comprising a presentation layer, a business logic layer, a data interface layer and a database;
wherein the presentation layer displays the data and receives the data input from the users, and the interactive operating interface of the presentation layer is created based on the desktop system of Linux;
wherein the business logic layer is used for business logic processing of the data provided by the data interface layer and provides the electronic game service to the presentation layer through the API interface. In which, the electronic game service at least includes the game management service, the device management service, the user management service and the application management service. The business logic layer also sets the multi-task scheduling module, the driver and update module of hardware and the combination of software and hardware application module;
wherein the data interface layer is used for the access of the database and provides the data service for the business logic layer and the presentation layer; and
wherein the database is used to cache the data provided by the data interface layer and persistently store the data in the cache.

2. An electronic game operating system based on Linux according to claim 1, wherein the multi-task scheduling module could be used to temporarily save the current game process according to the historical game data of users so that the users can switch different games; the aforementioned driver and update module of hardware could be used to manage and update the firmware and driver of the hardware, and the cloud server is tracked in real-time state in combination with the terminal device of the electronic game to ensure that the terminal device uses the verified latest version of firmware and driver; the aforementioned combination of software and hardware application module could achieve the function of opening a multifunctional menu in the electronic game interface through the combination of the aforementioned API interface and the physical function key, in which the aforementioned function key could be preset single key or combined key.

3. An electronic game operating system based on Linux according to claim 1, wherein the interactive operating interface of the aforementioned presentation layer provides the users with controller operation and touch operation and adapts to the size of the terminal equipment of electronic game. The presentation layer is developed based on the Electron framework and completes the interaction between users and data by means of WEB.

4. An electronic game operating system based on Linux according to claim 1, wherein the game management service is configured with PC game management, PC game metadata management, retro game management, retro game metadata management, controller settings and simulator settings; the aforementioned device management service is configured with WiFi management, bluetooth management, file management, time zone and time settings, device information view and device power consumption adjustment; the aforementioned user management service is configured with function of screenshots, sharing of screenshots and synchronization of game data; the aforementioned application management service is configured with application installation, application upgradation and application deletion.

5. An electronic game operating system based on Linux according to claim 1, wherein the data interface layer includes data cache, custom functions, transactions, database reading/writing, and files reading/writing; the database includes MySQL, Json, MongoDB, CDN.

6. An electronic game operating system based on Linux according to claim 1, wherein the database uses Redis cache to save the data provided by data interface layer, and realizes the concurrent preemption and processing of the data in cache of Redis, and the processed data could be persistently stored in the database through the message queue.

7. An electronic game operating system based on Linux according to claim 1, wherein the interactive operating interface of the presentation layer is created based on the Linux desktop system, which includes:
obtaining screen information of terminal devices of electronic game, which includes at least screen size and/or screen resolution;
based on the aforementioned screen information, the data provided by the business logic layer is configured to display the game list of the electronic game; and
receiving the operation request information of the quick functional area, and displaying the preset adjusting module of the quick functional area, which is used to adjust the power consumption state of the terminal devices, limiting the temperature of the terminal devices, and adjusting the screen brightness and volume of the terminal devices.

8. An electronic game operating system based on Linux according to claim 7, wherein the list of games contains at least the name and cover of the electronic game, and the quick functional area.

9. An electronic game operating system based on Linux according to claim 1, wherein the multi-task scheduling module comprising:
unit of creating process, used for creating data process of users that includes multiple task state queues, includes at least ready queue, wait queue, mutually exclusive queue, and end queue;
unit of finding task, is used to determine the priority of the running tasks according to the data process provided by the unit of creating process, and preemptively run according to the priority of tasks;
unit of timing, is used to set the time for unit of finding task;
unit of interrupting process, is used to call the preset entry function of interrupting process of Linux when the users interrupt the game process; and
unit of saving data, is used for saving game data processed by the unit of interrupting process.

10. An electronic game operating system based on Linux according to claim 1, further including the WiFi network module used for automatically scanning the available networks. The game content management module used to automatically import, identify, and optimize the local game content of users to ensure the comprehensive game experience.
